(19) United States
(12) Patent Application Publication
(10) Pub. No.: US 2025/0102804 A1
(43) Pub. Date: Mar. 27, 2025

(54) OPTICAL WAVEGUIDE ELEMENT AND HEAD-MOUNTED DISPLAY

(71) Applicant: ASUSTeK COMPUTER INC., Taipei City (TW)

(72) Inventors: Wen-Chang Hung, Taipei City (TW); Ting-Wei Huang, Taipei City (TW); Bo-Kai Zhang, Taipei City (TW); Ji-Ping Sheng, Taipei City (TW)

(73) Assignee: ASUSTeK COMPUTER INC., Taipei City (TW)

(21) Appl. No.: 18/774,913

(22) Filed: Jul. 16, 2024

(30) Foreign Application Priority Data
Sep. 27, 2023 (TW) 112210493

(51) Int. Cl. G02B 27/01; G02B 6/34

(52) U.S. Cl. CPC G02B 27/0172; G02B 6/34; G02B 2027/0123

(57) ABSTRACT

An optical waveguide element, including a first optical waveguide, a second optical waveguide, a third optical waveguide, and a grating, is provided. The second optical waveguide is disposed on the first optical waveguide. The third optical waveguide is disposed on the second optical waveguide. The grating is disposed between the first optical waveguide and the second optical waveguide. A refractive index of the second optical waveguide is smaller than a refractive index of the first optical waveguide and a refractive index of the third optical waveguide. A head-mounted display is also provided.

### CROSS-REFERENCE TO RELATED APPLICATION

This application claims the priority benefit of Taiwan application serial no. 112210493, filed on Sep. 27, 2023. The entirety of the above-mentioned patent application is hereby incorporated by reference herein and made a part of this specification.

### BACKGROUND

### Technical Field

The disclosure relates to an optical waveguide element and a head-mounted display.

### Description of Related Art

In an augmented reality (AR) device, a coupling grating is usually used to refract an image light incident on an optical waveguide to an angle greater than a critical angle, so that the image light is transmitted to a pupil expansion grating by total internal reflection (TIR) within the optical waveguide, and is transmitted to the human eye after one-dimensional or two-dimensional pupil expansion via the pupil expansion grating. Since the image light at different incident angles are totally reflected at different angles within the optical waveguide after passing through the coupling grating, the distances of one total internal reflection of the image light at different incident angles within the optical waveguide are inconsistent, which causes a difference in the number of times the image light at different incident angles contacts the pupil expansion grating, resulting in poor angular uniformity of the image transmitted to the human eye.

### SUMMARY

The disclosure provides an optical waveguide element, which includes a first optical waveguide, a second optical waveguide, a third optical waveguide, and a grating. The second optical waveguide is disposed on the first optical waveguide. The third optical waveguide is disposed on the second optical waveguide. The grating is disposed between the first optical waveguide and the second optical waveguide. A refractive index of the second optical waveguide is smaller than a refractive index of the first optical waveguide and a refractive index of the third optical waveguide.

The disclosure also provides a head-mounted display including a display and an optical waveguide element. The display is used to provide an image light. The optical waveguide element is disposed on a transmission path of the image light and includes a first optical waveguide, a second optical waveguide, a third optical waveguide, and a grating. The second optical waveguide is disposed on the first optical waveguide. The third optical waveguide is disposed on the second optical waveguide. The grating is disposed between the first optical waveguide and the second optical waveguide. A refractive index of the second optical waveguide is smaller than a refractive index of the first optical waveguide and a refractive index of the third optical waveguide.

In order for the features and advantages of the disclosure to be more comprehensible, the following specific embodiments are described in detail in conjunction with the drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 3 are respectively partial cross-sectional schematic views of three optical waveguide elements according to some embodiments of the disclosure.

FIG. 4 is a top schematic view of a grating according to some embodiments of the disclosure.

FIG. 5 is a schematic view of a head-mounted display according to some embodiments of the disclosure.

### DESCRIPTION OF THE EMBODIMENTS

Directional terms such as “upper”, “lower”, “front”, “rear”, “left”, and “right” mentioned in the disclosure are only directions with reference to the drawings. Therefore, the used directional terms are used to illustrate, but not to limit, the disclosure. In the drawings, each drawing illustrates the general characteristics of a method, a structure, and/or a material used in a specific embodiment. However, the drawings should not be construed to define or limit the scope or nature covered by the embodiments. For example, the relative sizes, thicknesses, and positions of various film layers, regions, and/or structures may be reduced or enlarged for clarity.

In the disclosure, the same or similar elements adopt the same or similar reference numerals, and redundant description thereof is omitted. In addition, features in different embodiments may be combined with each other without conflict, and simple equivalent changes and modifications made in accordance with the specification or the claims are still within the scope covered by the disclosure. In addition, terms such as “first” and “second” mentioned in the specification or the claims are only used to name different elements or distinguish different embodiments or scopes, and are not used to limit the upper limit or the lower limit of the number of elements, nor are they used to limit the manufacturing sequence or the arrangement sequence of elements.

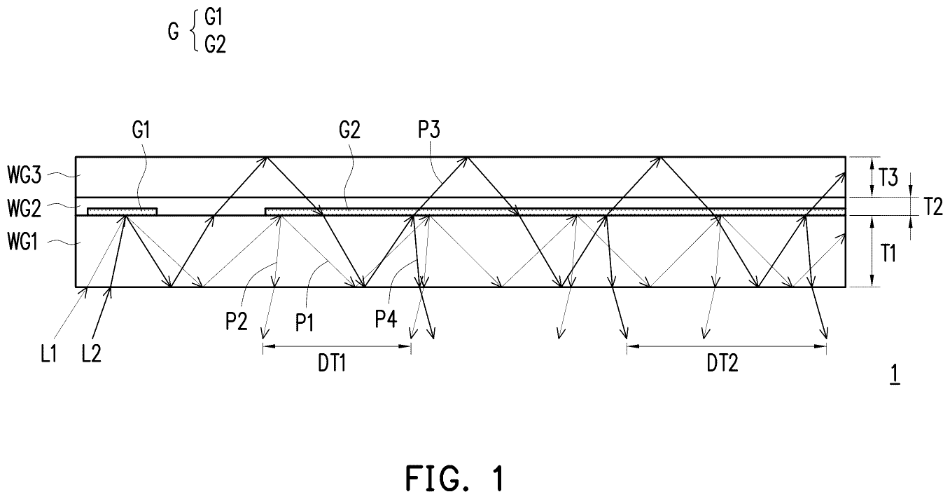

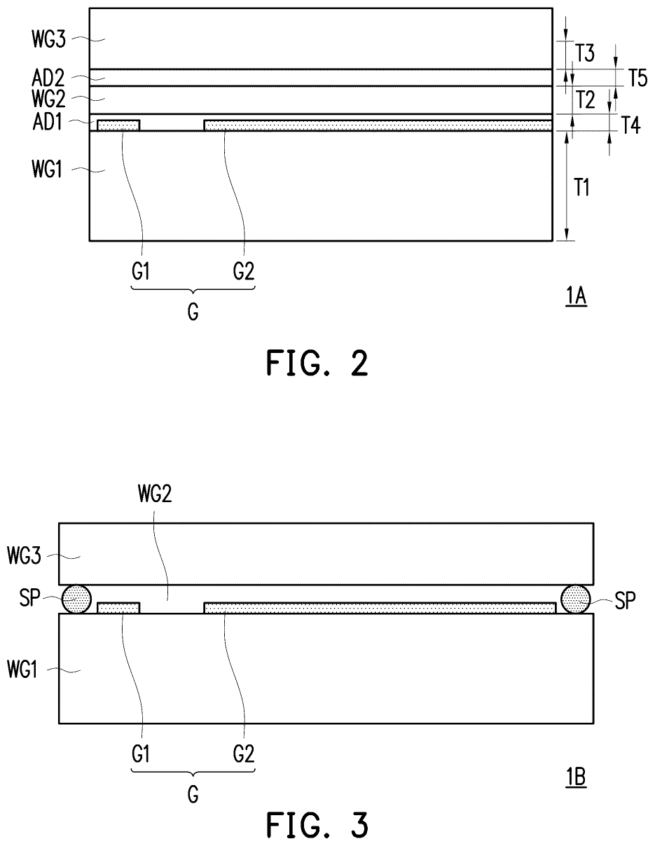

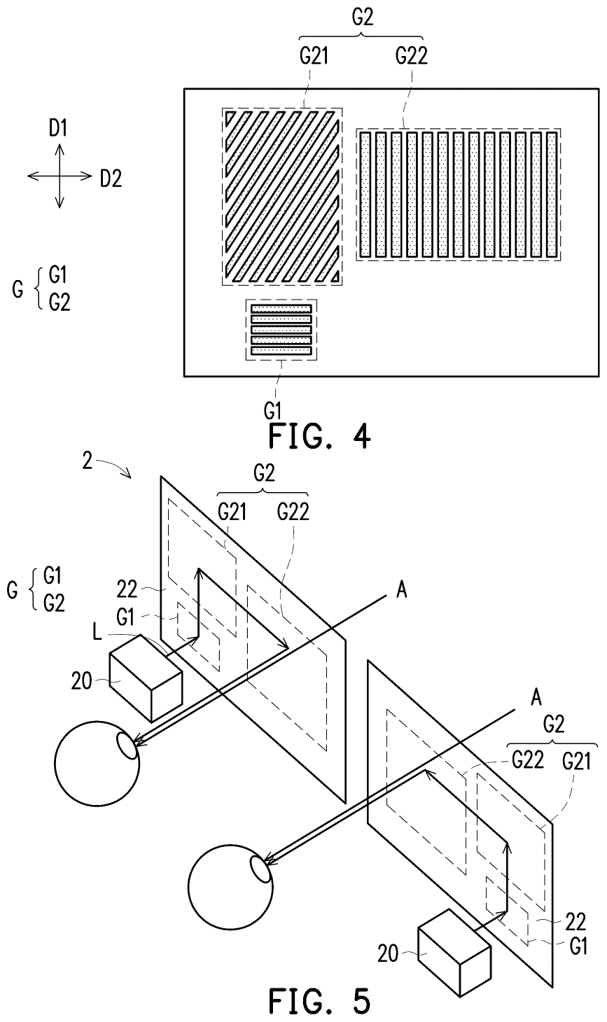

FIG. 1 to FIG. 3 are respectively partial cross-sectional schematic views of three optical waveguide elements according to some embodiments of the disclosure. FIG. 4 is a top schematic view of a grating according to some embodiments of the disclosure. FIG. 5 is a schematic view of a head-mounted display according to some embodiments of the disclosure.

Please refer to FIG. 1. An optical waveguide element 1 may include a first optical

waveguide WG1, a second optical waveguide WG2, a third optical waveguide WG3, and a grating G, wherein the second optical waveguide WG2 is disposed on the first optical waveguide WG1, the third optical waveguide WG3 is disposed on the second optical waveguide WG2, and the grating G is disposed between the first optical waveguide WG1 and the second optical waveguide WG2. In addition, the refractive index of the second optical waveguide WG2 is smaller than the refractive index of the first optical waveguide WG1 and the refractive index of the third optical waveguide WG3.

In the disclosure, through disposing an optical waveguide with a lower refractive index (for example, the second optical waveguide WG2) between two optical waveguides with higher refractive indexes (for example, the first optical waveguide WG1 and the third optical waveguide WG3), a critical angle may be used to limit transmission levels of image light at different incident angles. For example, an image light (for example, an image light L1) incident on the optical waveguide element 1 at a large angle has a diffraction angle greater than the critical angle at an interface between the first optical waveguide WG1 and the second optical waveguide WG2, so the image light maintains being transmitted within the optical waveguide element 1; and an image light (for example, an image light L2) incident on the optical waveguide element 1 at a small angle has a diffraction angle smaller than the critical angle at the interface between the first optical waveguide WG1 and the second optical waveguide WG2, so the image light passes through the second optical waveguide WG2 and is transmitted within the optical waveguide element 1, the second optical waveguide WG2, and the third optical waveguide WG3. Through increasing the optical path of the image light (for example, the image light L2) incident on the optical waveguide element 1 at a small angle and maintaining the optical path of the image light (for example, the image light L1) incident on the optical waveguide element 1 at a large angle, a distance difference of one total internal reflection between the image light at different incident angles (for example, a difference value between a distance DT1 and a distance DT2) within the optical waveguide can be shortened, which helps to improve angular uniformity.

Specifically, the first optical waveguide WG1 may be used as the main channel for image light transmission. In some embodiments, the refractive index of the first optical waveguide WG1 is within the range of 1.5 to 2 (that is, 1.5≤refractive index≤2). For example, the material of the first optical waveguide WG1 may be glass or other materials with refractive indexes within the range of 1.5 to 2. In some embodiments, a thickness T1 of the first optical waveguide WG1 is within the range of 0.05 mm to 2 mm (that is, 0.05 mm≤T1≤2 mm) to take into account both angular uniformity and structural strength.

The second optical waveguide WG2 may be disposed on the first optical waveguide WG1 and the grating G and is located between the first optical waveguide WG1 and the third optical waveguide WG3. The second optical waveguide WG2 is mainly used to limit the transmission level of the image light. In some embodiments, the refractive index of the second optical waveguide WG2 is within the range of 1.1 to 1.5 (that is, 1.1≤refractive index≤1.5), and the larger the field of view (FOV), the larger the refractive index of the second optical waveguide WG2. For example, the material of the second optical waveguide WG2 may be magnesium fluoride (MgF), calcium fluoride (MgCa), fluoride such as acrylic fluororesin, optical glue, or other materials with refractive indexes within the range of 1.1 to 1.5. In some embodiments, a thickness T2 of the second optical waveguide WG2 is within the range of 1 μm to 10 μm (that is, 1 μm≤T2≤10 μm) to take into account both angular uniformity and brightness.

The third optical waveguide WG3 may cover the grating G and the second optical waveguide WG2. In some embodiments, the refractive index of the third optical waveguide WG3 is within the range of 1.5 to 2 (that is, 1.5≤refractive index≤2). For example, the material of the third optical waveguide WG3 may be tempered glass or other materials with refractive indexes within the range of 1.5 to 2. In some embodiments, a thickness T3 of the third optical waveguide WG3 is within the range of 0.05 mm to 2 mm (that is, 0.05 mm≤T3≤2 mm) to take into account both angular uniformity and protection of underlying elements.

When the material of the second optical waveguide WG2 is optical glue, the third optical waveguide WG3 may be comprehensively attached to the first optical waveguide WG1 and the grating G through the optical glue (the second optical waveguide WG2), that is, the second optical waveguide WG2, for example, completely covers the grating G. Through the comprehensive attachment design, the issue of interface reflection caused by the presence of air between the third optical waveguide WG3 and the first optical waveguide WG1 can be improved, which helps to increase brightness or reduce stray light. In addition, the comprehensive attachment design can also reduce light loss or contrast reduction caused by environmental dust and water vapor pollution. In addition, the comprehensive attachment design can also improve overall safety and reduce possibility of glass bursting or splintering due to external impact.

The grating G may be disposed on the first optical waveguide WG1. In some embodiments, the grating G may be directly manufactured on the first optical waveguide WG1, and the type of the grating G may include surface relief grating (SRG), holographic polymer dispersed liquid crystal (HPDLC) grating, volume holographic grating (VHG), polarization volume grating (PVG), or other suitable grating types.

In some embodiments, the grating G may include a coupling grating G1 and a pupil expansion grating G2, wherein the coupling grating G1 may be used to couple the image light (for example, the image light L1 and the image light L2) incident on the optical waveguide element 1 into the first optical waveguide WG1, and the pupil expansion grating G2 may be used to implement one-dimensional or two-dimensional pupil expansion and transmit the image light (for example, the image light L1 and the image light L2) to the human eye. Taking FIG. 1 as an example, a portion (for example, a first portion P1) of the image light L1 incident on the pupil expansion grating G2 from the optical waveguide element 1 is reflected by the pupil expansion grating G2 and continues to be transmitted within the first optical waveguide WG1 by total internal reflection, and another portion (for example, a second portion P2) of the image light L1 incident on the pupil expansion grating G2 is refracted by the pupil expansion grating G2 and is thus output from the first optical waveguide WG1 and transmitted to the human eye. In addition, the pupil expansion grating G2 allows the light (for example, the image light L2) incident from the second optical waveguide WG2 to pass through, wherein a portion (for example, a third portion P3) of the image light L2 incident on the pupil expansion grating G2 from the optical waveguide element 1 passes through the pupil expansion grating G2 and continues to be transmitted within the first optical waveguide WG1, the second optical waveguide WG2, and the third optical waveguide WG3 by total internal reflection, and another portion (for example, a fourth portion P4) of the image light L2 incident on the pupil expansion grating G2 is refracted by the pupil expansion grating G2 and is thus output from the first optical waveguide WG1 and transmitted to the human eye.

In some examples, through disposing an optical waveguide with a lower refractive index between two optical waveguides with higher refractive indexes, and through controlling the refractive index and/or the thickness of each optical waveguide, an optical path difference between large and small angles can be shortened, so that the distances of one total internal reflection of image light at large and small angles approach consistency. Table 1 shows the distances of one total internal reflection at different incident angles under different thicknesses T3. In Table 1, all parameters except the thickness T3 are fixed values. For example, the refractive index of the first optical waveguide WG1 is 2, the thickness T1 of the first optical waveguide WG1 is 1 mm, the refractive index of the second optical waveguide WG2 is 1.2, the thickness T2 of the second optical waveguide WG2 is hundreds of times smaller than the thicknesses of other optical waveguides, so the thickness T2 may be neglected, and the refractive index of the third optical waveguide WG3 is 1.5. It can be seen from Table 1 that when T3=0.16 mm, the incident angle 31° and the incident angle 37° have similar distances of one total internal reflection, and the incident angle 33° and the incident angle 39° have similar distances of one total internal reflection, and the incident angle 35° and the incident angle 41° have similar distances of one total internal reflection. In other words, under such design, the optical path difference of about 6 degrees can be brought closer, that is, the distances of one total internal reflection of image light with an incident angle difference of 6 degrees can approach consistency.

TABLE 1

| | Distance of one | Distance of one | Distance of one |
|---|---|---|---|
| | total internal | total internal | total internal |
| | reflection | reflection | reflection |
| Incident | when T3 = | when T3 = | when T3 = |
| angle | 0.14 mm (mm) | 0.16 mm (mm) | 0.18 mm (mm) |
| 31° | 1.4662 | 1.5040 | 1.5418 |
| 33° | 1.5946 | 1.6368 | 1.6791 |
| 35° | 1.7328 | 1.7802 | 1.8277 |
| 37° | 1.5071 | 1.5071 | 1.5071 |
| 39° | 1.6196 | 1.6196 | 1.6196 |
| 41° | 1.7386 | 1.7386 | 1.7386 |
| 46° | 2.0711 | 2.0711 | 2.0711 |

In addition, compared to adopting a single optical waveguide with a higher refractive index to reduce the distance difference of one total internal reflection between large and small angles, the disclosure helps to expand the range of refractive indexes available for each optical waveguide through disposing an optical waveguide with a lower refractive index between two optical waveguides with higher refractive indexes and can also effectively reduce the distance differences of one total internal reflection between large and small angles under different FOVs. Table 2 shows the distance differences of one total internal reflection between an optical waveguide of a comparative example and optical waveguides of an example of the disclosure under different FOVs. In Table 2, the optical waveguide of the comparative example adopts a single substrate with a refractive index of 2 and a thickness of 1 mm, and the example adopts the structure as shown in FIG. 1, wherein in Table 2, all parameters except the refractive index n2 and the thickness T3 of the second optical waveguide WG2 are fixed values. For example, the refractive index of the first optical waveguide WG1 is 2, the thickness T1 of the first optical waveguide WG1 is 1 mm, the thickness T2 of the second optical waveguide WG2 is hundreds of times smaller than the thicknesses of other optical waveguides, so the thickness T2 may be neglected, and the refractive index of the third optical waveguide WG3 is 1.5. It can be seen from Table 2 that the disclosure can effectively reduce the distance differences of one total internal reflection between large and small angles under different FOVs through disposing an optical waveguide with a lower refractive index between two optical waveguides with higher refractive indexes.

TABLE 2

| | Distance difference of one | Distance difference of |
|---|---|---|
| FOV | total internal reflection of | one total internal |
| angle | comparative example (mm) | reflection of example (mm) |
| 30° | 0.8693 | 0.5505 |
| | | (n2 = 1.21; T3 = 0.22) |
| 35° | 1.2288 | 0.7639 |
| | | (n2 = 1.24; T3 = 0.26) |
| 40° | 1.5981 | 1.0256 |
| | | (n2 = 1.29; T3 = 0.32) |
| 45° | 2.046 | 1.402 |
| | | (n2 = 1.33; T3 = 0.36) |

Please refer to FIG. 2. The main difference between an optical waveguide element 1A and the optical waveguide element 1 of FIG. 1 is explained below. In the optical waveguide element 1A, the material of the second optical waveguide WG2 includes, for example, magnesium fluoride, calcium fluoride, or acrylic fluororesin. In addition, the optical waveguide element 1A further includes a first adhesion layer AD1 and a second adhesion layer AD2, wherein the first adhesion layer AD1 is disposed between the first optical waveguide WG1 and the second optical waveguide WG2, and the second adhesion layer AD2 is disposed between the second optical waveguide WG2 and the third optical waveguide WG3. For example, the second optical waveguide WG2 is comprehensively attached to the first optical waveguide WG1 through, for example, the first adhesion layer AD1, and the third optical waveguide WG3 is comprehensively attached to the second optical waveguide WG2 through, for example, the second adhesion layer AD2.

Through the comprehensive attachment design, the issue of interface reflection caused by the presence of air between the optical waveguides can be improved, which helps to increase brightness or reduce stray light. In addition, the comprehensive attachment design can also reduce light loss or contrast reduction caused by environmental dust and water vapor pollution. In addition, the comprehensive attachment design can also improve overall safety and reduce possibility of glass bursting or splintering due to external impact.

In some embodiments, the refractive indexes of the first adhesion layer AD1 and the second adhesion layer AD2 may be within the range of 1.5 to 1.6 (that is, 1.5≤refractive index≤1.6). In addition, the thicknesses (for example, a thickness T4 and a thickness T5) of the first adhesion layer AD1 and the second adhesion layer AD2 may be within the range of 1 μm to 100 μm (that is, 1 μm≤T4≤100 μm, 1 μm≤T5≤100 μm). That is, compared to the thickness T1 and the thickness T3, the thickness T4 and the thickness T5 are also negligible. Please refer to FIG. 3. The main difference between an optical waveguide element 1B

and the optical waveguide element 1 of FIG. 1 is explained below. In the optical waveguide element 1B, the material of the second optical waveguide WG2 includes, for example, optical glue. In addition, the optical waveguide element 1B further includes multiple supporting members SP, and the supporting members SP support between the first optical waveguide WG1 and the third optical waveguide WG2, so that the first optical waveguide WG1 and the third optical waveguide WG2 are flat to reduce probability of total internal reflection generating angular error due to unevenness. In some embodiments, the supporting members SP may be micro glass beads or other suitable supports.

FIG. 4 schematically illustrates one aspect of a grating that can implement two-dimensional pupil expansion. In some embodiments, as shown in FIG. 4, the pupil expansion grating G2 of any embodiment of the disclosure may include a first pupil expansion grating G21 and a second pupil expansion grating G22, wherein the first pupil expansion grating G21 may implement pupil expansion in a direction D1 and may be used to transmit the image light from the coupling grating G1 to the second pupil expansion grating G22, and the second pupil expansion grating G22 may implement pupil expansion in a direction D2 and may be used to transmit the image light from the first pupil expansion grating G21 to the human eye. It should be understood that in addition to the structure shown in FIG. 4, the grating of any embodiment of the disclosure may also adopt other known gratings.

Please refer to FIG. 5. A head-mounted display 2 may include a display 20 and an optical waveguide element 22. The display 20 is used to provide an image light L. For example, the display 20 may include a liquid crystal display, a digital light processing (DLP) projector, a liquid crystal on silicon (LCoS) display, a laser scanning system, or any permutation and combination of the above, but not limited thereto. The optical waveguide element 22 is disposed on a transmission path of the image light L. The optical waveguide element 22 may adopt the structure of any of the above embodiments, which will not be repeated here.

In some embodiments, the head-mounted display 2 may be in the form of glasses, wherein the display 20 may be fixed on the temples, and the optical waveguide element 22 may be installed in the frame. In addition to transmitting the image light L from the display 20 to the eyes of a user, the optical waveguide element 22 may also allow an ambient light A to pass through, which helps to implement the augmented reality function, but the disclosure is not limited thereto. According to different requirements, the head-mounted display 2 may adopt other forms and/or include other elements.

In summary, in the embodiment of the disclosure, through disposing an optical waveguide with a lower refractive index between two optical waveguides with higher refractive indexes, the distance difference of one total reflection between the image light at different incident angles within the optical waveguide can be shortened, which helps to improve angular uniformity.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An optical waveguide element, comprising:
a first optical waveguide;
a second optical waveguide, disposed on the first optical waveguide;
a third optical waveguide, disposed on the second optical waveguide; and
a grating, disposed between the first optical waveguide and the second optical waveguide,
wherein a refractive index of the second optical waveguide is smaller than a refractive index of the first optical waveguide and a refractive index of the third optical waveguide.

2. The optical waveguide element according to claim 1, wherein the refractive index of the first optical waveguide is within a range of 1.5 to 2, the refractive index of the second optical waveguide is within a range of 1.1 to 1.5, and the refractive index of the third optical waveguide is within the range of 1.5 to 2.

3. The optical waveguide element according to claim 1, wherein a thickness of the first optical waveguide is within a range of 0.05 mm to 2 mm, a thickness of the second optical waveguide is within a range of 1 μm to 10 μm, and a thickness of the third optical waveguide is within the range of 0.05 mm to 2 mm.

4. The optical waveguide element according to claim 1, wherein the grating comprises a coupling grating and a pupil expansion grating, and the pupil expansion grating allows light incident from the second optical waveguide to pass through.

5. The optical waveguide element according to claim 1, wherein a material of the second optical waveguide is optical glue, and the second optical waveguide completely covers the grating.

6. The optical waveguide element according to claim 5, further comprising:
a plurality of supporting members, supporting between the first optical waveguide and the third optical waveguide.

7. The optical waveguide element according to claim 1, wherein a material of the second optical waveguide comprises magnesium fluoride, calcium fluoride, or acrylic fluororesin.

8. The optical waveguide element according to claim 7, further comprising:
a first adhesion layer, disposed between the first optical waveguide and the second optical waveguide; and
a second adhesion layer, disposed between the second optical waveguide and the third optical waveguide.

9. The optical waveguide element according to claim 8, wherein refractive indexes of the first adhesion layer and the second adhesion layer are within a range of 1.5 to 1.6.

10. The optical waveguide element according to claim 8, wherein thicknesses of the first adhesion layer and the second adhesion layer are within a range of 1 μm to 100 μm.

11. A head-mounted display, comprising:
a display, used to provide an image light; and
an optical waveguide element, disposed on a transmission path of the image light and comprising:
a first optical waveguide;
a second optical waveguide, disposed on the first optical waveguide;
a third optical waveguide, disposed on the second optical waveguide; and
a grating, disposed between the first optical waveguide and the second optical waveguide,
wherein a refractive index of the second optical waveguide is smaller than a refractive index of the first optical waveguide and a refractive index of the third optical waveguide.

12. The head-mounted display according to claim 11, wherein the refractive index of the first optical waveguide is within a range of 1.5 to 2, the refractive index of the second optical waveguide is within a range of 1.1 to 1.5, and the refractive index of the third optical waveguide is within the range of 1.5 to 2.

13. The head-mounted display according to claim 11, wherein a thickness of the first optical waveguide is within a range of 0.05 mm to 2 mm, a thickness of the second optical waveguide is within a range of 1 μm to 10 μm, and a thickness of the third optical waveguide is within the range of 0.05 mm to 2 mm.

14. The head-mounted display according to claim 11, wherein the grating comprises a coupling grating and a pupil expansion grating, and the pupil expansion grating allows light incident from the second optical waveguide to pass through.

15. The head-mounted display according to claim 11, wherein a material of the second optical waveguide is optical glue, and the second optical waveguide completely covers the grating.

16. The head-mounted display according to claim 15, wherein the optical waveguide element further comprises:
a plurality of supporting members, supporting between the first optical waveguide and the third optical waveguide.

17. The head-mounted display according to claim 11, wherein a material of the second optical waveguide comprises magnesium fluoride, calcium fluoride, or acrylic fluororesin.

18. The head-mounted display according to claim 17, wherein the optical waveguide element further comprises:
a first adhesion layer, disposed between the first optical waveguide and the second optical waveguide; and
a second adhesion layer, disposed between the second optical waveguide and the third optical waveguide.

19. The head-mounted display according to claim 18, wherein refractive indexes of the first adhesion layer and the second adhesion layer are within a range of 1.5 to 1.6.

20. The head-mounted display according to claim 18, wherein thicknesses of the first adhesion layer and the second adhesion layer are within a range of 1 μm to 100 μm.
